(19) United States
(12) Patent Application Publication
(10) Pub. No.: US 2012/0311040 A1
(43) Pub. Date: Dec. 6, 2012

(54) REAL-TIME BROWSING MONITORING

(76) Inventor: Dror Sherzer, Ramat-Gan (IL)

(21) Appl. No.: 13/431,241

(22) Filed: Mar. 27, 2012

Related U.S. Application Data
(60) Provisional application No. 61/492,395, filed on Jun. 2, 2011.
(60) Provisional application No. 61/492,402, filed on Jun. 2, 2011.

(51) Int. Cl. G06F 15/16

(52) U.S. Cl. 709/204

(57) ABSTRACT

A computerized apparatus and computer program product. The apparatus comprising a processor that is arranged to obtain browsing information from a plurality of software agents operated by computerized clients of users, wherein the computerized clients are utilized for browsing the one or more web locations, wherein the browsing information indicating the one or more web locations browsed to by the users; and to calculate, based on the browsing information, a number of users that are browsing substantially each one or more web locations at substantially the same time.

### CROSS-REFERENCE TO RELATED APPLICATIONS

This application claims the benefit of U.S. provisional patent application No. 61/492,402 entitled “Location-oriented interactive social network aggregation service” filed Jun. 2, 2011, and of U.S. provisional patent application No. 61/492,395 entitled “Location-oriented real-time interaction detection service” filed Jun. 2, 2011, which are both hereby incorporated by reference in their entirety.

### TECHNICAL FIELD

The present disclosure relates to web browsing in general, and to monitoring of browsing activities and enabling social interaction of users, in particular.

### BACKGROUND

Today's Internet environment is increasingly becoming user-oriented. Users interact via social networks, email, instant messaging, Voice Over IP (VoIP) services, presence feeds and similar method. Attempting to mimic the physical realm relations, users operate in online social networks. Those virtual social environments allow to converse with real-life friends and acquaintances, share information and perform operations in a group-oriented fashion.

In the computerized environment, interaction between users may be established based on pre-existing connections, such as people that are acquainted with each other or have common friends. This type of confined behavior is counter to the human nature, which thrives on ad-hoc relations. Humans interact with previously unknown individuals while commuting to work, browsing merchandise in shopping malls, waiting for a dentist appointment, and similar social encounters.

### BRIEF SUMMARY

One exemplary embodiment of the disclosed subject matter is a computerized apparatus comprising a processor coupled with a memory device, wherein said processor is arranged to: obtain browsing information from a plurality of software agents operated by computerized clients of users, wherein the computerized clients are utilized for browsing the one or more web locations, wherein the browsing information indicating the one or more web locations browsed to by the users; and calculate, based on the browsing information, a number of users that are browsing substantially each one or more web locations at substantially the same time.

Another exemplary embodiment of the disclosed subject matter is a computer program product comprising a non-transitory computer readable medium including a computer program, wherein the computer program when executed on a computer causes the computer to: obtain browsing information from a plurality of software agents operated by computerized clients of users, wherein the computerized clients are utilized for browsing the one or more web locations, wherein the browsing information indicating the one or more web locations browsed to by the users; and calculate, based on the browsing information, a number of users that are browsing substantially each one or more web locations at substantially the same time.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIG. 2A shows a flowchart diagram of a method for monitoring web browsing information and utilization thereof, in accordance with some exemplary embodiments of the disclosed subject matter;

FIG. 2B shows a flowchart diagram of a method for analyzing real-time browsing information, in accordance with some exemplary embodiments of the disclosed subject matter;

FIG. 2C shows a flowchart diagram of a method for performing a web search, in accordance with some exemplary embodiments of the disclosed subject matter;

FIG. 3A shows a diagram of a computerized client, in accordance with some exemplary embodiments of the disclosed subject matter;

FIG. 3B shows a diagram of a computerized server, in accordance with some exemplary embodiments of the disclosed subject matter;

FIGS. 4A and 4B show illustration of a web page display by a computerized client, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to enable location-oriented interaction in the computerized environment. Location-oriented interaction has the advantages of enabling mining valuable information in place and time needed the most. In some cases, it is most likely that people that are located in a certain place at a certain time, will have certain relevant information. As an example, consider a doctor's waiting room, it is most likely that information regarding when the doctor will be free may be held by people in that room. As another example, a person reading a blog may be more likely to be knowledgeable in the subject matter of the blog than a random person.

Another technical problem is to determine whether other people are located in the same web location at the same time.

A “web location” in the disclosed subject matter is a location associated with one or more browseable objects, such as web pages. In some exemplary embodiments, a site may be a web location, such that all the different web pages of the website may be considered as the same web location. Additionally or alternatively, different portions of a website may be considered as different web locations, such as different departments, different sub-domains, or the like. In some exemplary embodiments, a web location may be a single web page. It will be understood that a browseable object may be an HTML web page, a FLASH file, an image, or any other file type that a web browser is capable of accessing and displaying to a user. In some exemplary embodiments, the browseable object is accessed using a communication protocol such as HTTP, HTTPS, or the like.

Yet another technical problem is to enable interaction between users browsing the same web location at the same time without having the web location be a-priori configured to enable such interaction.

Yet another technical problem is to provide a search engine which is based on real-time activity of users.

One technical solution is to utilize a software agent in the computerized clients of the users. The software agent being configured to monitor browsing activities by the users, thereby monitoring the current web location of each user. The software agents being configured to transmit the monitored information to a server. The server may be configured to calculate, based on the monitored information, a number of users that are browsing each web location at substantially the same time.

In some exemplary embodiments, the software agent are further configured to display an interaction pane over each a web page that is associated with a web location, thereby enabling interaction of users accessing the same web location. Additionally or alternatively, an indication that other users are currently browsing the same web location may be provided to the user, thereby encouraging utilization of the interaction pane when other users may be communicated with. In some exemplary embodiments, the interaction pane may comprise a real-time chat widget. Additionally or alternatively, the interaction pane may comprise a location-based interaction widget of a social network, such as a web-page comments widget of Facebook®, or the like.

Another technical solution is to provide a variety of software agents. In some exemplary embodiments, a first software agent may be a-priori installed on the computerized client, thereby all browsing activities of the user may be monitored. The first software agent may be installed as a dedicated web browser, an extension for a generic web browser, or the like. In some exemplary embodiments, a second software agent may be operated on-demand, such as in response to accessing a specific web-page. The second software agent may be configured to monitor browsing activity within the web-page. In some exemplary embodiments, the first software agent may be configured to override the second software agent, or vise versa, thereby ensuring that the browsing activity of the user is monitored exactly once.

Yet another technical solution is to compute a number of users accessing the same web location based on a reference timeframe. The software agents may be configured to periodically report the monitored web location of the user. Based on the reports received within a reference timeframe, a number of users that are browsing the same web location is determined. In some exemplary embodiments, the reference timeframe may be modified based on a number of users that are browsing the web location, such that the more users browsing the web location, the reference timeframe may be extended.

Yet another technical solution is to order a web search query result list based on a number of users browsing with each result in real-time.

Yet another technical solution is to have the software agents retrieve social interactions, such as comments, like indications, or the like, from a social network. In some exemplary embodiments, the software agent that has received the information may be configured to update the server with the social interactions thereby bypassing a restriction by the social network regarding number of queries to the social network from the same source. In some exemplary embodiments, crowdsourcing may be performed with respect to a plurality of software agents to obtain social interactions that are associated with web locations within the social network.

Yet another technical solution is to map between a web page, such as based on its Uniform Resource Locator (URL), and a web location. In some exemplary embodiments, the mapping may be one one-to-one, many-to-one, or many-to-many. In some exemplary embodiments, a web page that is accessible to limited number of users, such as a web page of an email inbox, may be filtered out.

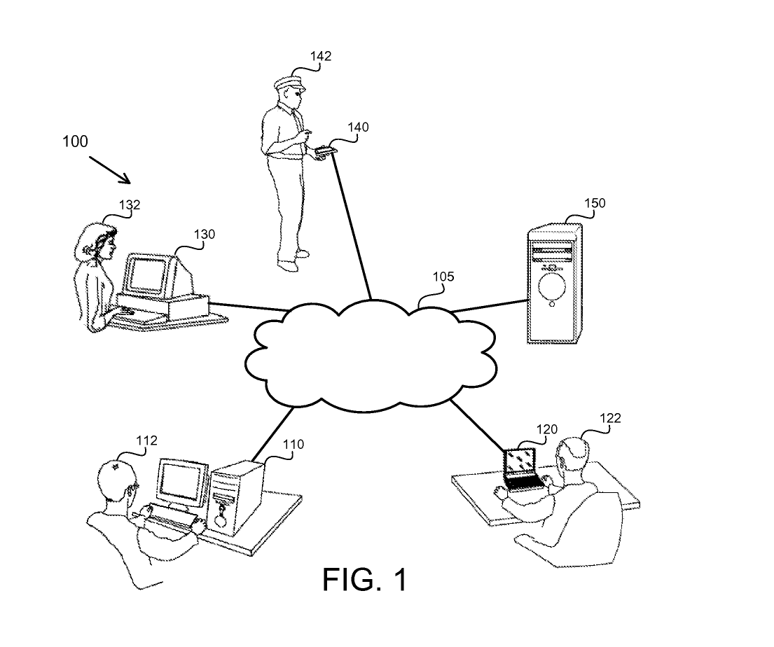

Referring now to FIG. 1 showing a computerized environment in which the disclosed subject matter is used, in accordance with some exemplary embodiments of the subject matter.

A computerized environment 100 comprises a plurality of computerized clients, such as 110, 120, 130 and 140, interconnected using a computerized network 105, such as the Internet, an intranet, or the like. In some exemplary embodiments, a computerized server 150 may also be connected to the network 105. Each computerized client may be operated by a user (112, 122, 132, 142). The users may browse web pages using a web browser using the computerized clients. The computerized client may access the web page over the network 105. Additionally or alternatively, the computerized client may be configured to monitor the browsing activity and report thereof to the server 150. In some exemplary embodiments, the clients may be adapted to obtain social interactions from one or more social networks (not shown) over the network 105 and output to the users relevant interactions to the web location in which the user is browsing. Additionally or alternatively, the clients may report to the server 150 the social interactions thereby the server 150 may be crowdsourcing the one or more social networks and optionally bypassing a restriction of a number of queries to the social networks by the same source.

In some exemplary embodiments, in case two or more users are browsing the same web location (e.g., the same web page, or different web pages that logically mapped to a single web location), the users may be notified that other users are located in the same web page, such as by an auditory or visual cue. In some exemplary embodiments, the users may interact with one another using real-time chat, using a comment posting system, or the like. In some exemplary embodiments, the interactions may be persistent. Alternatively, the interactions may be dropped once the users seize to interact.

It will be noted that a computerized client may be a laptop computer, a desktop computer, a Personal Digital Assistant (PDA), a smartphone, a mobile device, a tablet computer, or the like.

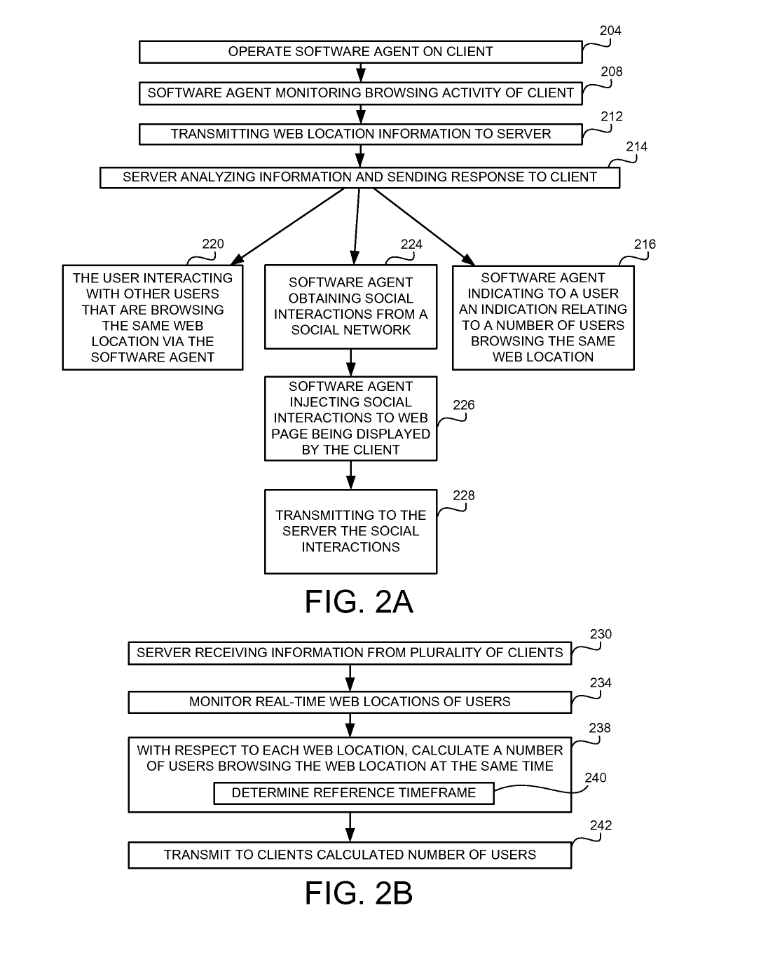

Referring now to FIG. 2A showing a flowchart diagram of a method for monitoring web browsing information and utilization thereof, in accordance with some exemplary embodiments of the disclosed subject matter.

In Step 204, a software agent may be operated in the client. In some exemplary embodiments, the software agent may be a-priori installed, e.g. as an extension of a web browser or as an integral portion of the web browser. Additionally or alternatively, the software agent may not be a-priori installed and may be retrieved on demand based on a command in a web page being accessed by the web browser. In some exemplary embodiments, the web page may comprise a code snippet that is configured, upon execution by the client, to operate the software agent. Other ad-hoc activation of the software agent may be utilized.

In Step 208, the software agent may be monitoring the browsing activity of the client. In some exemplary embodiments, the software agent may monitor the address of the web page being accessed and/or displayed by the browser, such as Microsoft® Internet Explorer®, Mozilla® FireFox®, Google® Chrome®, or the like. In some exemplary embodiments, the software agent may monitor all browsing activity of the client as the software agent is configured to be activated no matter which web page is being accessed. Additionally or alternatively, in case the software agent is not installed on the client but is activated ad-hoc in response to browsing the predefined web site, the software agent may monitor only browsing activities within the web site.

In some exemplary embodiments, in case the web page being browsed to is a web location that is accessible to a limited number of users, such as only the user, or a limited group of users that have login credentials, the disclosed subject matter may avoid monitoring browsing such limited-access web locations. In some exemplary embodiments, identifying a limited accessibility web page may be performed actively by inspecting the content of the web page, pertinent credentials, session object, or the like. Additionally or alternatively, limited accessibility may ignored passively by recording a number of users accessing each web location (e.g., at any time or at substantially the same time) and ignoring web pages which do not reach at least a predetermined threshold number of users.

In Step 212, monitored web location information may be transmitted to a server, such as 105. In some exemplary embodiments, the transmission may be periodic, such as occurring once in a minute to repeatedly report the one or more web locations of the client. In some exemplary embodiments, the period of reporting may change based on a number of users that are considered to be browsing the same web-location at substantially the same time. As an example, in case there are 10 users, the periodic report may be performed every 60 seconds, whereas if there are over a thousand users, the period report may be performed every 5 minutes. In some exemplary embodiments, the periodic report may be based on a reference timeframe, which is disclosed hereinbelow.

In Step 214, the server may analyze the information received. In some exemplary embodiments, in response to said analysis by the server, the server may send a response to the client. In some exemplary embodiments, the server may analyze information received from a plurality of clients each having a software agent activated thereon, and the server may send the response to each such client. The client may receive the response and perform accordingly either or all of Steps 216-228.

In Step 216, in response to a determination by the server that in addition to the user of the client other users are browsing the same web location substantially concurrently with the user, the software agent may provide an indication to the user of the virtual presence of the other users. In some exemplary embodiments, the indication may be a label, optionally flashing or otherwise being highlighted, indicating a number (e.g., 112) or an approximated number (e.g., 100+) of users that are determined to be currently located in the same web location as the user. In some exemplary embodiments, the indication may be an auditory cue, such as a beeping sound. Other sensory indicators may be utilized.

In Step 220, the user may interact with other users that are browsing the same web location. The interaction may be performed via the software agent, such as using a chat widget, a bulletin board widget, or the like. In some exemplary embodiments, the interaction may be performed using a social network interaction widget, such as using page-based comments widget of Facebook®, page-based tweets of tweeter®, or the like.

In some exemplary embodiments, the users may interact without having an a-priori relationship therebetween, thereby achieving an ad-hoc location-based real-time interaction.

In Step 224, the software agent may obtain social interactions from a social network and in Step 228, the social interactions may be displayed or otherwise outputted to the user.

In some exemplary embodiments, the social interactions may be associated with a location object, such as an object associated with the web location. Therefore, social interactions associated with the web location may be obtained by obtaining all social interactions associated with the pertinent object. In some exemplary embodiments, the object may be defined based on the URL of the web page or a URL associated with the web location (e.g., domain name of the web site, partial URL of the web page, a prefix of the URL of the web page, the URL of the web page excluding query string parameters, or the like). In some exemplary embodiments, the social network may be configured to enable social interactions associated with a location object, such as posting comments using the social network relating to a certain web page. In some exemplary embodiments, a dedicated widget of the social network, such as Facebook®'s comments widget may be introduced to the web page and may be configured to obtain and display the social interactions associated with the object.

It will be noted that in some exemplary embodiments, the designer of the web page may define and introduce a social network widget that is associated with the object. The social interactions that are shown by the social network widget may be displayed again in the injected content. Thus, in case an object is pre-defined, the injected content is associated with the social interactions that are inherent to the design of the web page and makes use thereof

In some exemplary embodiments, the social interactions may be injected by the software agent to the web page being displayed by the browser of the client. In some exemplary embodiments, the injection may be performed by injecting a widget that is configured to obtain and display the social interactions. In some exemplary embodiments, the injection is performed so as to enable a user to selectively display or hide the social interactions. It will be noted that the injection may thus modify a designed look-and-feel of a web page. In some exemplary embodiments, the web page designer may not design the web page to include the injected content. For example, the web page designer or manager may design a promotional web page in which users cannot post comments. The disclosed subject matter modifies the web page's functionality and enables the users to interact and post comments relating to the content of the web page, without having the manager to configure the web site accordingly.

In some exemplary embodiments, in case the social network does have an object that is associated with the web location, the software agent may define a new object and add the object to the social network, thereby introducing to the social network the object.

In Step 228, the software agent may transmit the social interactions to the server, such as 105. Thus, the server may be provided with the social interactions associated with the web location without having to perform a query to the social network. In some exemplary embodiments, the social network may enforce a restriction on a number of queries issued by a single source. By having the software agents obtain the information themselves and provide the information to the server, the social network information is crowdsourced using a plurality of computerized clients, thereby the restriction may be practically bypassed.

In some exemplary embodiments, in case several software agents receive the same information, such as several software agents obtain the same social interactions which are associated with the same web location, only a portion thereof, and preferably only one of them, may update the server to avoid duplicate content and to reduce unnecessary bandwidth utilization. In some exemplary embodiments, the server may determine which of the software agents is responsible of updating the server with obtained information, and provide such determination (e.g., in Step 214).

Referring now to FIG. 2A showing a flowchart diagram of a method for monitoring web browsing information and utilization thereof, in accordance with some exemplary embodiments of the disclosed subject matter.

In Step 230, the server, such as 105, may receive information from a plurality of software agents (e.g., information transmitted in Step 212).

In Step 234, based on the information provided by the software agents, the real-time web locations of each user may be monitored. In some exemplary embodiments, in case no information is received with respect to a specific user, the server may determine that the user is still located in its previous web location or alternatively, that the user is not located in any web location. In some exemplary embodiments, the determination that the user is not located in any web location is determined if the pertinent software agent does not provide any information for a predetermined timeframe.

In some exemplary embodiments, each URL being accessed by the user and reported to the server by the software agent may be mapped to a web location.

In Step 238, with each to each web location, a number of users that are browsing the web location at the same time may be determined. In some exemplary embodiments, two users may be considered to be browsing at substantially the same time in case their respective software agents reported a URL mapped to the web location during a reference timeframe. In some exemplary embodiments, the reference timeframe may be a constant timeframe, such as a timeframe of a one minute duration. In some exemplary embodiments, the reference timeframe may be determined dynamically (240) such as for example based on the number of users that were previously reported as being located in the web location. In some exemplary embodiments, the more users that are reported as being located in the web location, the longer the reference timeframe may be. In some exemplary embodiments, a longer reference timeframe is justified to allow all software agents to periodically report without causing an overload of the system. Additionally or alternatively, the longer reference timeframe is further justified as the resolution may be less important when dealing with a large number of users (e.g., it is not substantially important to report that a single user out of a thousand has left the web location, as opposed to reporting that a single user out of five users has left).

In Step 242, the server may transmit to the clients the calculated number of users. Optionally, the server may also transmit a relevant reference timeframe for each web location so as to allow the software agent to report periodically based on the determined reference timeframe.

Referring now to FIG. 2C showing a flowchart diagram of a method for performing a web search, in accordance with some exemplary embodiments of the disclosed subject matter.

In Step 250, a web page search query from a client may be received. In some exemplary embodiments, the client may or may not have a software agent activated thereon.

In Step 260, the query may be performed, based on static data, such as content of the web pages, hyperlinks and other linking mechanism between the web pages, or the like. It will be noted that the static data may be modified dynamically, such as by a user posting data to a web page, by modifying links, or the like. However, “static data” in the meaning of the disclosed subject matter is opposed to real-time data relating to users that are browsing the web page.

In Step 270, search results of the web search may be filtered based on dynamic data relating to real-time information of visitors of web locations associated with each web page. For example, a web page in which there are a number of current visitors below a predetermined threshold, such as one user, ten users, thousand users, or the like, may be filtered out and ignored. Thus, the search results may be tuned to web pages which are of current interest to the public of users.

In Step 280, the remaining search results may be ordered based on the dynamic data. In some exemplary embodiments, the search results may be ordered based on a “social score”. A “social score” may be a measurement quantifying page popularity by based on its social action metrics. The social score may be calculated for each web page based on dynamic data, such as current number of visitors in a corresponding web location, number of social interactions associated with the web location and their content, or the like. In some exemplary embodiments, only a portion of the social interactions which are timed within a predetermined timeframe prior to the search query may be utilized to compute the social score. In some exemplary embodiments, the social score may further be based on a freshness factor. The “freshness factor” is a metric measuring how recent the web page is. For example, the freshness factor may be based on an a date of creation of the web page in the web location, on a date of modification of the web page, on a date in which a user last visited the web location, or the like. In some exemplary embodiments, the freshness factor enables giving preference to more recent pages given similar popularity.

In some exemplary embodiments, the social score may factor geographic and demographic information of different users. In some exemplary embodiments, the popularity within similar geographical and/or demographical characteristics of the user performing the web search may be taken into account.

In some exemplary embodiments, the search results may be ordered based on relevance to the search criteria and in combination with the social score.

In some exemplary embodiments, the search results may be ordered to show first the web pages which are associated with web locations that have the highest current number of visitors. Hence, the search result may be ordered so as to give precedence to web sites which the public finds most intriguing at the moment.

In Step 290, the search results may be transmitted, such as in a form of a search result web page, to the requesting client.

It will be noted that a search engine in accordance with FIG. 2C takes advantage of the monitored web locations of the users, such as depicted in FIG. 2A.

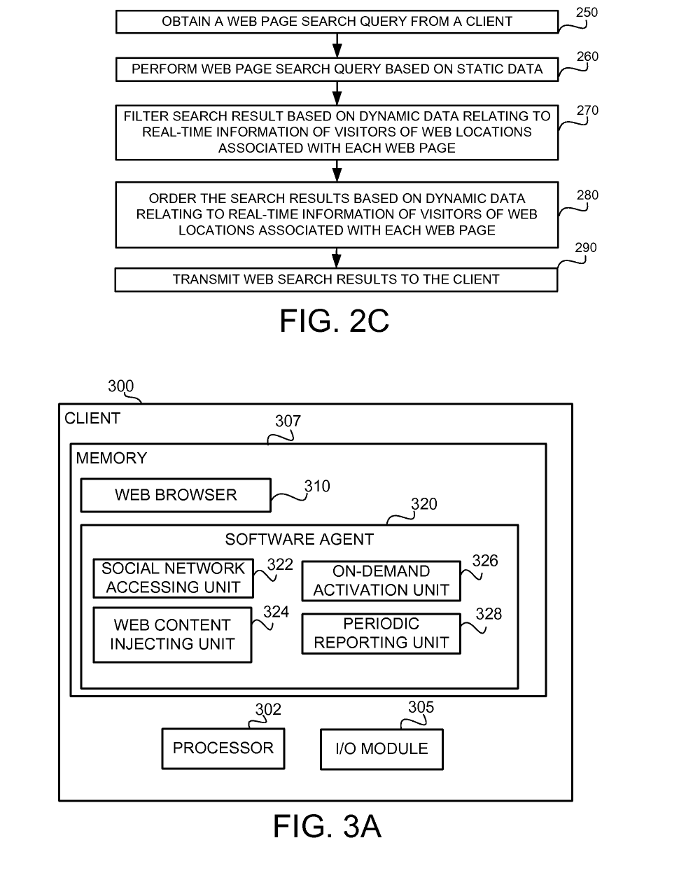

FIG. 3A shows a diagram of a computerized client, in accordance with some exemplary embodiments of the disclosed subject matter. A Client 300, such as 110 of FIG. 1, may be configured to perform the method of FIG. 2A.

In some exemplary embodiments, Client 300 may comprise a Processor 302. Processor 302 may be a Central Processing Unit (CPU), a microprocessor, an electronic circuit, an Integrated Circuit (IC) or the like. Processor 302 may be utilized to perform computations required by Client 300 or any of it subcomponents.

In some exemplary embodiments of the disclosed subject matter, Client 300 may comprise an Input/Output (I/O) Module 305. I/O Module 305 may be utilized to provide an output to and receive input from a user, such as 112 of FIG. 1. Furthermore, I/O Module 305 may be configured to connect with a network, such as 105, and to transmit and receive data over the network.

In some exemplary embodiments, Client 300 may comprise a Memory 307. Memory 307 may be a hard disk drive, a Flash disk, a Random Access Memory (RAM), a memory chip, or the like. In some exemplary embodiments, Memory 307 may retain program code operative to cause Processor 302 to perform acts associated with any of the subcomponents of Client 300.

A Web Browser 310 may be retained in Memory 307. Web Browser 310 may be configured to browse web sites, such as using HTTP or a similar protocol.

A Software Agent 320 may be configured to monitor the browsing activity of Web Browser 310. Software Agent 320 may report the monitored browsing activity to a server, such as 105.

In some exemplary embodiments, Software Agent 320 may be a-priori installed on Client 300. Additionally or alternatively, Software Agent 320 may be activated on-demand based on Web Browser 310 accessing a web page that is configured to cause activation of Software Agent 320. An On-Demand Activation Unit 326 may be configured to cause the on-demand loading and activation of Software Agent 320 in response to accessing a web page.

A Social Network Accessing Unit 322 may be configured to access a social network and obtain social interactions therefrom.

A Web Content Injecting Unit 324 may be configured to modify a web page by injecting additional content thereto. The additional content may be injected as an overlay widget containing interactions. In some exemplary embodiments, the overlay widget may be an interactive widget which may be selectively shown or hidden. In some exemplary embodiments, the overlay widget may comprise one or more widgets of social networks, wherein each such social network widget is operable to display social interactions from the social network that are associated with the web location.

A Periodic Reporting Unit 328 may be configured to periodically report to the server the browsing activity of Web Browser 310. In some exemplary embodiments, the period of reporting by Periodic Reporting Unit 328 may be based on a reference timeframe.

Referring now to FIG. 3B showing a diagram of a computerized server, in accordance with some exemplary embodiments of the disclosed subject matter. Server 350 may comprise Processor 302, I/O Module 305 and Memory 307, similarly to Client 300. Server 350 may be configured to perform methods such as depicted in FIGS. 2B and 2C.

A Real-Time Client Monitoring Module 354 may be configured to monitor the real-time web locations of all clients whose location is reported, such as Client 300.

A Reference Timeframe Calculator 358 may be configured to calculate and determine a reference timeframe with respect to each web location. The reference timeframe may be based on a calculated number of users browsing the web location.

A Real-Time Crowd Counter 362 may be configured to count, with respect to a web location, a number of users that are located in the web location in real-time and at the same time.

A Social Network Crowdsourcing Module 364 may be configured to crowdsource clients, such as Client 300, to obtain information from social networks.

A Web Page To Web Location Mapping Module 368 may be configured to determine a web location based on a web page. In some exemplary embodiments, there may be a one-to-one relationship, such that each web page may have a different web location. Additionally or alternatively, there may be many-to-one relationship, such that several web pages (e.g., pages in the same web site) are mapped to the same web location. In some exemplary embodiments, the mapping may be based on the URL of the web page. The mapping may ignore a postfix of the URL, such as query string parameters.

A Real-Time Search Engine 372 may be operative to perform a web search and to filter and/or order the search results based on real-time dynamic data.

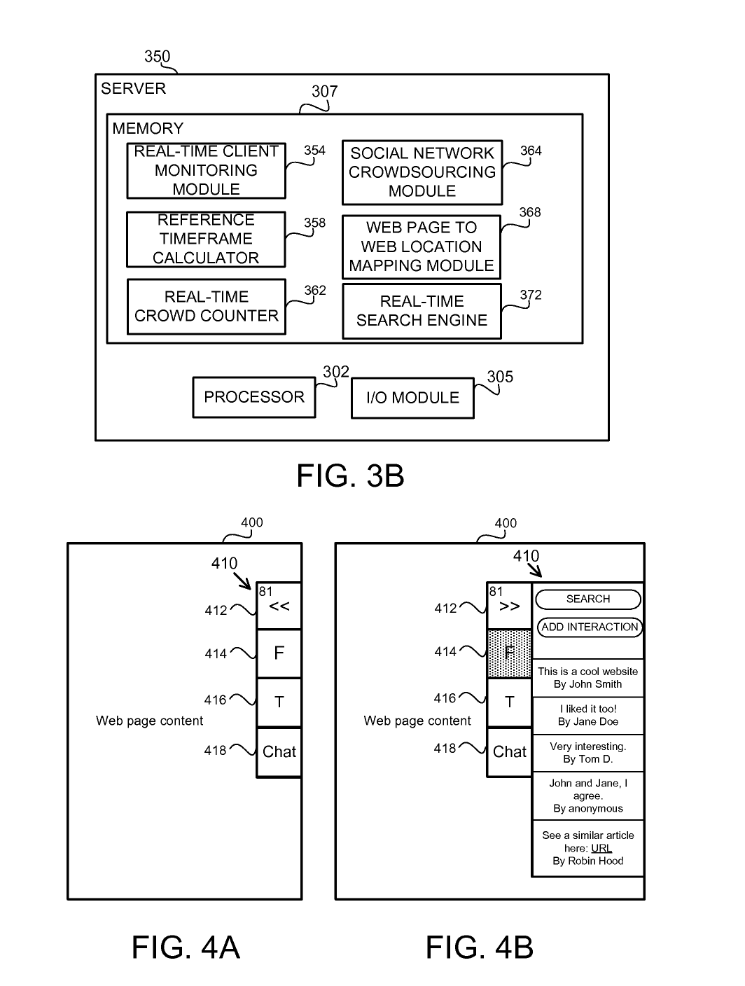

Referring now to FIGS. 4A and 4B show illustration of a web page display by a computerized client, in accordance with some exemplary embodiments of the disclosed subject matter. Display 400 shows a web page having an Interaction Pane 410. Interaction Pane 410 may have a substantially hidden mode (FIG. 4A) and a displayed mode (FIG. 4B). Button 412 may be operative to change between the modes. Pane 410 may be overlayed over the web page content. In some exemplary embodiments, Pane 410 may hover over the web page, such that scrolling to left/right and/or up/down does not change the location of the pane.

In some exemplary embodiments, Button 412 provides an indication as to a number of users that are in the same web location as the user, thereby indicating to the user whether or not there is a point to interacting with other users. In the present example, 81 other users are browsing the same web location. It will be noted that the number is based on monitoring performed by software agents in accordance with the disclosed subject matter and therefore it may be a smaller number than the actual number of all users that are browsing the same web location.

In some exemplary embodiments, different buttons may be associated with social interactions provided in different social networks or widgets. For example, Button 414 may be associated with comments posted via Facebook®, Button 416 may be associated with tweets posted via Tweeter®, and Button 418 is associated with a real-time chat widget.

In response to pressing Button 414, the mode of Interaction Pane 414 may be changed to displayed mode. Furthermore, the content of Pane 410 may include social interactions associated with the web location of the displayed web page that are posted via Facebook®. The comments may include text, hyperlinks, or the like. In some exemplary embodiments, the posts may be presented in the web page content itself, such as in case the designer of the web page included a Facebook® comments widget. In some exemplary embodiments, the user may post an interaction to the Pane 410 and perform a search on the posted comments using the Pane 410.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computerized apparatus comprising a processor coupled with a memory device, wherein said processor is arranged to:
obtain browsing information from a plurality of software agents operated by computerized clients of users, wherein the computerized clients are utilized for browsing the one or more web locations, wherein the browsing information indicating the one or more web locations browsed to by the users; and
calculate, based on the browsing information, a number of users that are browsing substantially each one or more web locations at substantially the same time.

2. The computerized apparatus of claim 1, wherein each of the plurality of software agents is capable of indicating to the user an indication relating to a number of users browsing the same web location as the user.

3. The computerized apparatus of claim 2, wherein the plurality of software agents are operative to enable interaction between users that are browsing the same web location, and whereby a user is capable of initiating an interaction with other users in response to an indication that other users are browsing the same web location.

4. The computerized apparatus of claim 1, wherein the plurality of software agents comprise at least a first and a second agent;
wherein the first agent is a-priori installed on a first computerized client of a first user; and
wherein the second agent is not a-priori installed on a second computerized client of a second user, wherein the second agent is configured to be activated in response to the second user browsing to a web page.

5. The computerized apparatus of claim 4, wherein the first agent is either installed as an extension of a web browser or installed as an integral part of the web browser.

6. The computerized apparatus of claim 4, whereby the first agent is capable of monitoring browsing activity of the first user with respect to any web location; and
whereby the second agent is capable of monitoring browsing activity of the second user only with respect to a web location associated with the web page.

7. The computerized apparatus of claim 1, wherein calculating the number of users that are browsing a web location comprises:
determining a reference timeframe; and
counting a number of reports by different software agents of respective users browsing the web location that were received within the reference timeframe.

8. The computerized apparatus of claim 7, wherein the reference timeframe is determined based on a previously calculated number of users browsing a web location.

9. The computerized apparatus of claim 7, wherein the software agents are configured to report periodically of a web location; and wherein a period of reporting is associated with the reference timeframe.

10. The computerized apparatus of claim 1, wherein said processor is further arranged to:
based on a search query by a user operating a computerized client, perform a web page search, thereby producing web search results;
compute a social score with respect to web locations associated with the web search results;
order the web search results based on the social score; and
transmit to the computerized client the ordered web search results.

11. The computerized apparatus of claim 10, wherein the social score is computed based on at least one of the following:
a number of users in the web locations;
a number of social interactions associated with the web locations; and
content of the social interactions associated with the web locations.

12. The computerized apparatus of claim 11, wherein the social score is further computed based on: a freshness measurement web pages.

13. The computerized apparatus of claim 1, wherein the software agents are configured to obtain social interactions associated with the web location from a social network, wherein the software agents are further configured to output the social interactions to the users.

14. The computerized apparatus of claim 13, wherein said processor is further arranged to receive from the software agents the social interactions, thereby the computerized apparatus is able to bypass a restriction of the social network regarding number of queries to the social network.

15. The computerized apparatus of claim 13, wherein said processor is further arranged to crowdsource to receive social interactions associated with the web locations.

16. The computerized apparatus of claim 13, wherein the software agents are configured to add to the social network an object associated with the web location in response to a determination that no such object exists with respect to the web location.

17. The computerized apparatus of claim 16, whereby users are enabled to socially interact with respect to the web location without prior configuration by a manager of the web location.

18. The computerized apparatus of claim 13, wherein the social interactions are comments by users via a social network, wherein the comments are associated with the web location.

19. The computerized apparatus of claim 1, wherein said processor is further arranged to avoid monitoring web locations which are accessible to a limited number of users.

20. A computer program product comprising a non-transitory computer readable medium including a computer program, wherein the computer program when executed on a computer causes the computer to:
obtain browsing information from a plurality of software agents operated by computerized clients of users, wherein the computerized clients are utilized for browsing the one or more web locations, wherein the browsing information indicating the one or more web locations browsed to by the users; and
calculate, based on the browsing information, a number of users that are browsing substantially each one or more web locations at substantially the same time.
